(19) United States
(12) Patent Application Publication
(10) Pub. No.: US 2013/0008686 A1
(43) Pub. Date: Jan. 10, 2013

(54) WIRE HARNESS AND METHOD FOR MANUFACTURING THE SAME

(75) Inventors: Shinichi Igarashi, Yokkaichi-City (JP); Hiroaki Masuda, Yokkaichi-City (JP); Nobumasa Takihara, Yokkaichi-City (JP); Yasunori Imada, Yokkaichi-City (JP); Mitsuru Kurita, Yokkaichi-City (JP); Yukihiro Shirafuji, Yokkaichi-City (JP)

(73) Assignee: SUMITOMO WIRING SYSTEMS, LTD., Yokkaichi-City (JP)

(21) Appl. No.: 13/580,403

(22) PCT Filed: Oct. 6, 2010
(86) PCT No.: PCT/JP2010/067507

§ 371 Date: Aug. 22, 2012

(30) Foreign Application Priority Data
Mar. 30, 2010 (JP) 2010-076558

(51) Int. Cl. H01B 7/17; H01R 43/00

(52) U.S. Cl. 174/110 R; 29/825

(57) ABSTRACT

It is an object of the present invention to provide a wire harness that has a simple structure, that can be easily manufactured, and that includes a protective member having an extra-length absorbing function. A wire harness (1) includes an electrical wire bundle (12) and a protective member (21). The protective member (21) is a member obtained by heat-molding a nonwoven fabric, covers a portion in the longitudinal direction of the electrical wire bundle (12), and has a spiral shape or helical shape in which a curved portion is formed with a continuous turn in the longitudinal direction or has a meander shape in which a plurality of curved portions are formed with intermittent turns in the longitudinal direction.

### BACKGROUND OF THE INVENTION

1. Field of the Invention

The present invention relates to a wire harness including a protective member covering part of an electrical wire, and a method for manufacturing the same.

2. Description of the Related Art

A wire harness disposed in vehicles represented by automobiles is formed sufficiently longer than the shortest wiring path, in order to allow the wire harness to be easily attached to electrical components and to follow movement of electrical components arranged at a movable portion. Such a wire harness for a vehicle is easily brought into contact with another member such as an automotive body panel due to vibrations or the like. If the wire harness is brought into contact with another member, the wire harness is damaged and noise is generated.

Thus, in order to prevent damage and noise of the wire harness due to contact of the extra length portion of the wire harness with another member, the wire harness for a vehicle may include an extra-length absorbing mechanism and a protective member.

For example, JP 2000-353438A discloses a protective member-attached wire harness produced by inserting electrical wires through a resin protective tube shaped in advance into a helical shape. In this wire harness, the stretchable helix-shaped protective tube functions as the extra-length absorbing mechanism of the wire harness and also as the protective member.

Furthermore, JP 2002-354634A discloses a protective member-attached wire harness produced by inserting electrical wires shaped into a helical shape through a stretchable grommet. In this wire harness, the grommet functions as the protective member of the wire harness, and the stretchable grommet and the electrical wires shaped in advance into a helical shape function as the extra-length absorbing mechanism of the wire harness.

Furthermore, JP 2006-314176A discloses a wire harness including a mechanism in which part of the wire harness is accommodated in a wound state inside a case, and extended from the case as necessary. In this wire harness, the case that accommodates the wire harness functions as the extra-length absorbing mechanism of the wire harness and also as the protective member.

Meanwhile, JP 2003-197038A discloses a structure that protects a flat circuit member while maintaining its thinness, produced by placing the flat circuit member between two cover members made of thermoplastic nonwoven fabrics and performing press molding thereon.

However, the protective member-attached wire harnesses disclosed in JP 2000-353438A and JP 2002-354634A are problematic in that the production operation, that is, the operation that inserts electrical wires through a cylindrical protective member such as a helix-shaped protective tube or a grommet is very complicated. Furthermore, the protective member-attached wire harnesses disclosed in JP 2000-353438A and JP 2002-354634A are problematic also in that, if a relatively large member such as a connector is attached in advance to the electrical wires, the wire harnesses cannot be produced by inserting the electrical wires into the cylindrical protective member.

Furthermore, in the extra-length absorbing mechanism disclosed in JP 2006-314176A, the structure is complicated, and adjusting the positional relationship between the wire harness and the case that accommodates the wire harness is difficult. Accordingly, the extra-length absorbing mechanism disclosed in JP 2006-314176A is problematic in that, if it is applied to mass-produced goods such as wire harnesses for a vehicle, disadvantages in the number of manufacturing steps and the cost become significant. Furthermore, JP 2003-197038A discloses no extra-length absorbing mechanism of a wire harness.

It is an object of the present invention to provide a wire harness that has a simple structure, that can be easily manufactured, and that includes a protective member having an extra-length absorbing function.

### SUMMARY OF THE INVENTION

The present invention is directed to a wire harness including an electrical wire and a protective member, wherein the protective member is a member obtained by heat-molding a nonwoven fabric, covers a portion in a longitudinal direction of the electrical wire, and has a curved portion formed with a continuous or intermittent turn in the longitudinal direction.

More specifically, at least part of the protective member may form a two-dimensional curve, and may have a spiral shape in which a curved portion is formed with a continuous turn in the same turning direction in the longitudinal direction.

Furthermore, at least part of the protective member may form a three-dimensional curve, and may have a helical shape in which a curved portion is formed with a continuous turn in the same turning direction in the longitudinal direction.

Furthermore, at least part of the protective member may form a two-dimensional curve, and may have a meander shape in which a plurality of curved portions are formed with intermittent turns in alternating turning directions in the longitudinal direction.

Moreover, the present invention is directed to a method for manufacturing a wire harness that includes an electrical wire and a protective member covering a portion in a longitudinal direction of the electrical wire, the method including:

(1) a first step of covering the portion in the longitudinal direction of the electrical wire with a nonwoven fabric;

(2) a second step of heating the nonwoven fabric covering the portion of the electrical wire in a mold, thereby molding the nonwoven fabric into the protective member in a shape of a cylinder covering the portion of the electrical wire;

(3) a third step of curving at least part of the protective member that has been molded in the second step into a shape in which a curved portion is formed with a continuous or intermittent turn in the longitudinal direction; and

(4) a fourth step of cooling down the protective member that has been curved in the third step, while keeping the protective member curved.

More specifically, the third step may be a process that winds the protective member that has been molded in the second step, around a rod-like support portion, in one turning direction in a sequentially overlapping manner, thereby causing at least part of the protective member to form a two-dimensional curve, and to be curved into a spiral shape in which a curved portion is formed with a continuous turn in the same turning direction in the longitudinal direction.

Furthermore, the third step may be a process that winds the protective member that has been molded in the second step, around a rod-like support portion, in one turning direction not in an overlapping manner, thereby causing at least part of the protective member to form a three-dimensional curve, and to be curved into a helical shape in which a curved portion is formed with a continuous turn in the same turning direction in the longitudinal direction.

Furthermore, the third step may be a process that catches the protective member that has been molded in the second step on each of a plurality of rod-like support portions arranged in a line such that the protective member turns in alternating turning directions, thereby causing at least part of the protective member to form a two-dimensional curve, and to be curved into a meander shape in which a plurality of curved portions are formed with intermittent turns in alternating turning directions in the longitudinal direction.

In the wire harness according to the present invention, the protective member is disposed so as to cover a portion that may be brought into contact with another member, thereby making it possible to prevent the electrical wire from being damaged. Furthermore, the protective member is a member obtained by heat-molding a nonwoven fabric. Accordingly, the protective member is very light, shock-absorbing, and flexible. Thus, when the protective member is brought into contact with another member, hardly any noise is generated.

Furthermore, the protective member in which a curved portion is formed with a turn in the longitudinal direction keeps the shape in the longitudinal direction of the electrical wire in a shape in which a curved portion is formed. Furthermore, since the protective member is flexible, the degree of curve of the curved portion changes according to a tensile force applied to the electrical wire, and, therefore, the apparent length of the protective member changes. That is to say, the protective member in which a curved portion is formed has an extra-length absorbing function.

Moreover, the wire harness according to the present invention can be easily manufactured merely by following the procedure in which a portion in the longitudinal direction of the electrical wire is covered by the nonwoven fabric, the nonwoven fabric is molded through the application of heat in a mold, and the molded protective member is continuously or intermittently curved and is then cooled down before the protective member is cured. Furthermore, the wire harness according to the present invention has a simple structure in which constituent elements such as a case for accommodating the electrical wire are not necessary, and thus can be manufactured at a low cost.

### BRIEF DESCRIPTION OF DRAWINGS

FIG. 1 is a perspective view of a wire harness 1 according to a first embodiment of the present invention.

FIG. 2 is a schematic perspective view showing an example of a hot pressing mold used to manufacture wire harnesses 1, 2, and 3 according to embodiments of the present invention.

FIG. 3 is a cross-sectional view of the hot pressing mold.

FIG. 4 is a view showing a first example of a nonwoven fabric enclosing process in the manufacturing process of the wire harnesses 1, 2, and 3 according to the embodiments of the present invention.

FIG. 5 is a view showing a second example of a nonwoven fabric enclosing process in the manufacturing process of the wire harnesses 1, 2, and 3 according to the embodiments of the present invention.

FIG. 6 is a view showing a first example of a hot pressing process in the manufacturing process of the wire harnesses 1, 2, and 3 according to the embodiments of the present invention.

FIG. 7 is a view showing a second example of a hot pressing process in the manufacturing process of the wire harnesses 1, 2, and 3 according to the embodiments of the present invention.

FIG. 8 is a perspective view of the wire harness including a protective member molded by the hot pressing process.

FIG. 9 is a perspective view showing a curving process in the manufacturing process of the wire harness 1 according to the first embodiment of the present invention.

FIG. 10 is a perspective view of a wire harness 2 according to a second embodiment of the present invention.

FIG. 11 is a perspective view showing a curving process in the manufacturing process of the wire harness 2 according to the second embodiment of the present invention.

FIG. 12 is a perspective view of a wire harness 3 according to a third embodiment of the present invention.

FIG. 13 is a perspective view showing a curving process in the manufacturing process of the wire harness 3 according to the third embodiment of the present invention.

### DETAILED DESCRIPTION OF THE PREFERRED EMBODIMENTS

Hereinafter, embodiments of the present invention will be described with reference to the drawings. The following embodiments are merely specific examples of the present invention, and are not to restrict the technical scope of the present invention. Wire harnesses 1, 2, and 3 according to the following embodiments of the present invention are wire harnesses including a protective member having a function of protecting electrical wires and a function of absorbing an extra length of the electrical wires, that is, protective member-attached wire harnesses.

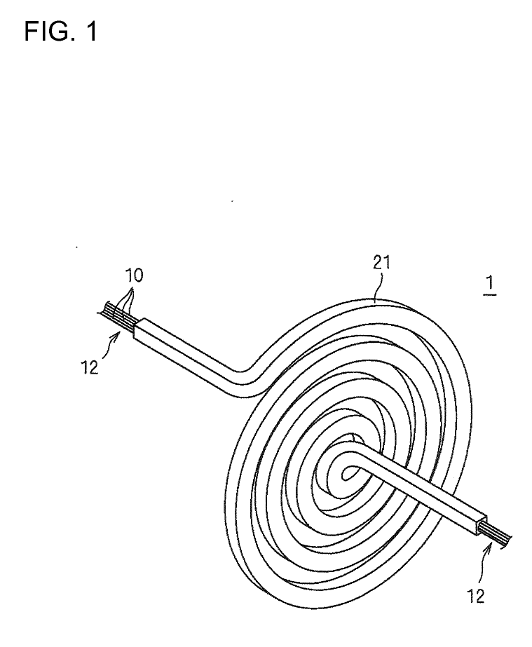

First, the configuration of a wire harness 1 according to the first embodiment of the present invention will be described with reference to FIG. 1.

As shown in FIG. 1, the wire harness 1 includes an electrical wire bundle 12 configured by a plurality of electrical wires 10, and a protective member 21. Note that, although the wire harness 1 shown in this embodiment is configured by a plurality of electrical wires 10, the number of electrical wires may be one. The protective member 21 is a member obtained by heat-molding a nonwoven fabric.

Hereinafter, the material of the protective member 21 will be described. As the nonwoven fabric for forming into the protective member 21, for example, a nonwoven fabric may be used containing base fibers that are entangled with each other and an adhesive resin that is referred to as “binder”. The adhesive resin is a resin having a melting point that is lower than the melting point of the base fibers (e.g., having a melting point of approximately 110 to 150° C.). When such a nonwoven fabric is heated to a temperature lower than the melting point of the base fibers and higher than the melting point of the adhesive resin, the adhesive resin is melted and enters gaps between the base fibers. Subsequently, when the temperature of the nonwoven fabric drops to a temperature lower than the melting point of the adhesive resin, the adhesive resin is cured while binding the base fibers around the adhesive resin together. Accordingly, the nonwoven fabric becomes harder than before heating, and is kept in the shape provided by the molding using a mold at the time of heating.

The adhesive resin is, for example, a particle-like resin, a fiber-like resin, or the like. Furthermore, the adhesive resin may be formed so as to cover the portion of a core fiber. A fiber having a structure in which the core fiber is covered by the adhesive resin in this manner is referred to as a “binder fiber” or the like. The core fiber is made of, for example, the same material as that for the base fibers.

Furthermore, the base fibers may be any fiber as long as the fibrous state is maintained at the melting point of the adhesive resin, and not only resin fibers but also other various fibers may be used as the base fibers. Furthermore, as the adhesive resin, for example, a thermoplastic resin fiber having a melting point lower than the melting point of the base fibers is used. As a combination of the base fibers and the adhesive resin forming the nonwoven fabric, for example, resin fibers mainly made of PET (polyethylene terephthalate) may be used as the base fibers, and a copolymer resin of PET and PEI (polyethylene isophthalate) may be used as the adhesive resin. In such a nonwoven fabric, the melting point of the base fibers is approximately 250° C., and the melting point of the adhesive resin is approximately 110 to 150° C. When such a nonwoven fabric is heated to a temperature of approximately 110 to 250° C. in the mold and is then cooled down, the adhesive resin is melted to bind the base fibers around the adhesive resin together, and, therefore, the nonwoven fabric is molded into a shape along the inner face of the mold.

Note that, although the nonwoven fabric after being heated in the mold is kept in the shape along the inner face of the mold, it can be easily deformed to any shape before the temperature decreases to a temperature sufficiently lower than the melting point of the adhesive resin. Accordingly, when the nonwoven fabric after being heated in the mold is shaped into another shape before the temperature decreases to a temperature sufficiently lower than the melting point of the adhesive resin, and is then cooled down to a temperature sufficiently lower than the melting point of the adhesive resin while maintaining the shape, the nonwoven fabric is shaped into a shape obtained by deforming the shape of the mold. The protective member 21 is molded by heating such a nonwoven fabric in the mold.

As shown in FIG. 1, the protective member 21 is a cylindrical member that is disposed so as to cover a portion in the longitudinal direction of the electrical wire bundle 12. The protective member 21 is disposed at the whole or part of a remaining range excluding two end portions in the longitudinal direction of the electrical wire bundle 12. Furthermore, a plurality of protective members 21 may be arranged on one electrical wire bundle 12.

In the example shown in FIG. 1, the protective member 21 is formed such that a cross-section orthogonal to the longitudinal direction of the electrical wire bundle 12 is in the shape of a rectangle. Note that the cross-sectional shape of the protective member 21 may be a shape other than a rectangle, such as a circular shape, an elliptical shape, a semicircular shape, a hexagonal shape, or other polygonal shapes. Furthermore, the cross-sectional shape of the protective member 21 may vary depending on the position in the longitudinal direction of the electrical wire bundle 12.

The inner side of the protective member 21 is in close contact with the electrical wire bundle 12 in a relatively soft state close to the state of the nonwoven fabric itself. Accordingly, even when vibrations are applied to the wire harness 1, no noise due to a collision between the electrical wire bundle 12 and the protective member 21 is generated. On the other hand, the outer face of the protective member 21 is molded by hot pressing into a relatively hard state. Note that the hot pressing will be described later.

Furthermore, in the protective member 21, a remaining portion excluding portions close to both ends forms a two-dimensional curve, and is shaped into a spiral shape. The spiral shape shown in FIG. 1 is a shape in which a curved portion is formed with a continuous turn substantially in the shape of an arc in the same turning direction in the longitudinal direction of the protective member 21 such that the degree of curve is gradually lowered from the inner side to the outer side.

In the wire harness 1, the protective member 21 is disposed so as to cover a portion that may be brought into contact with another member, thereby preventing the electrical wire bundle 12 from being damaged. Furthermore, the protective member 21 is a member obtained by heat-molding the nonwoven fabric by hot pressing. Accordingly, the protective member 21 is very light, shock-absorbing, and flexible. When such a protective member 21 is brought into contact with another member, hardly any noise is generated.

Furthermore, the spiral-shaped protective member 21 keeps the shape in the longitudinal direction of the electrical wire bundle 12 in a spiral shape. Furthermore, since the protective member 21 is flexible, the degree of curve of the curved portion changes according to a tensile force applied to the electrical wire bundle 12, that is, according to a tensile force that stretches out the electrical wire bundle 12 in the shape of a straight line, and, therefore, the apparent length of the protective member 21 changes. That is to say, the protective member 21 formed in a spiral shape has an extra-length absorbing function.

Furthermore, the wire harness 1 is on the whole very thin and flat. Accordingly, the wire harness 1 is particularly preferably applied when there are restrictions that a wire harness having a function of protecting the electrical wire bundle 12 and a function of absorbing an extra length of the electrical wire bundle 12 has to be disposed in a narrow space.

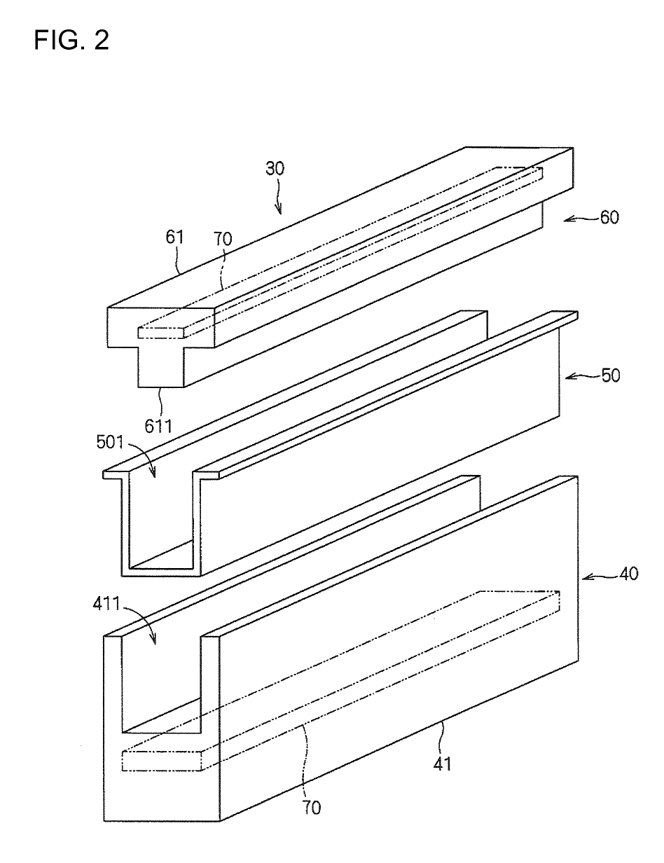

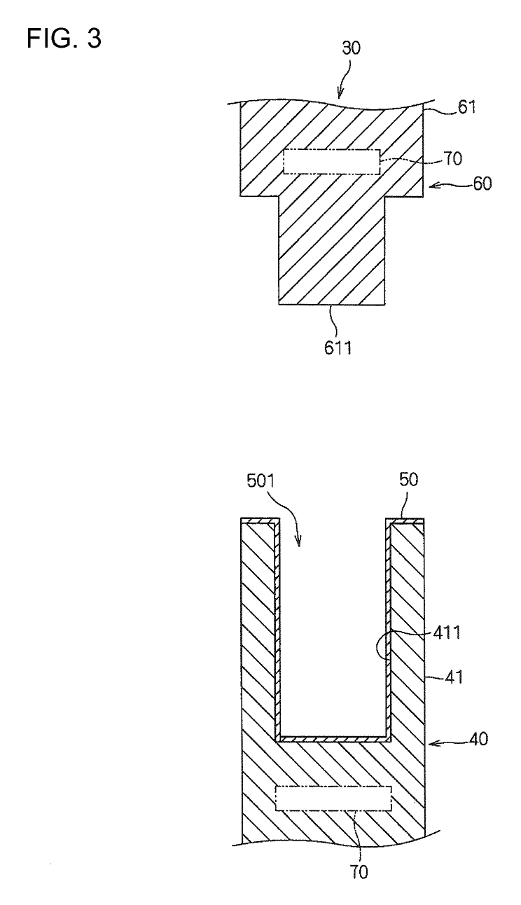

Next, an example of a hot pressing mold 30 used to manufacture the wire harness 1 will be described with reference to FIGS. 2 and 3. Note that the hot pressing mold 30 shown below can be also used to manufacture a wire harness 2 and a wire harness 3 according to other embodiments, which will be described later. The hot pressing mold 30 is used in the hot pressing on the nonwoven fabric. The hot pressing is a process that presses and heats the nonwoven fabric in a state where the nonwoven fabric that is to be processed is held between mold units, thereby molding the nonwoven fabric into the shape along the inner face of mold units.

FIG. 2 is a perspective view showing an example of the hot pressing mold 30 used in the hot pressing on the protective member 21. As shown in FIG. 2, the hot pressing mold 30 includes a lower mold unit 40, a lower mold holding tool 50, and an upper mold unit 60.

The lower mold unit 40 includes a lower mold member 41 and a heater 70. The lower mold member 41 is an elongated member made of a material such as metal having an excellent thermal conductivity, and has one face (upper face) on which a lower mold receiving portion 411 is formed. The lower mold receiving portion 411 is formed in the shape of a groove in which the upper portion and both ends in the longitudinal direction are open, and has a rectangular cross-sectional shape.

Furthermore, the lower mold holding tool 50 is an elongated member made of a material such as metal having an excellent thermal conductivity, and is placed on the lower mold receiving portion 411 of the lower mold member 41 in a freely detachable manner. The lower mold holding tool 50 is, for example, a member obtained by bending a plate-like member made of metal.

The lower mold holding tool 50 has one face (upper face) on which a lower mold frame portion 501 is formed. The lower mold frame portion 501 is formed in the shape of a groove in which the upper portion and both ends in the longitudinal direction are open, and has a rectangular cross-sectional shape. The lower mold frame portion 501 of the lower mold holding tool 50 functions as a mold frame that shapes a lower portion in the hot pressing on the nonwoven fabric for forming into the protective member 21.

FIG. 3 shows a state in which the lower mold holding tool 50 is attached to the lower mold receiving portion 411. The lower face of the lower mold holding tool 50 is formed in the same shape as the lower mold receiving portion 411 of the lower mold member 41. Accordingly, when the lower mold holding tool 50 is attached to the lower mold receiving portion 411, as shown in FIG. 3, the lower face of the lower mold holding tool 50 is brought into close contact with and fitted to the inner face of the groove-like lower mold receiving portion 411.

The lower mold holding tool 50 is a member for facilitating an operation of setting the nonwoven fabric and the electrical wire bundle 12 between the lower mold unit 40 and the upper mold unit 60, and an operation of taking out a protective member obtained by molding the nonwoven fabric after the hot pressing and before forming a curved portion. Accordingly, the lower mold holding tool 50 is not an essential member for hot pressing, and may be omitted. If the lower mold holding tool 50 is omitted, the lower mold receiving portion 411 of the lower mold member 41 functions as a mold frame that shapes a lower portion in the hot pressing on the nonwoven fabric for forming into the protective member 21.

The upper mold unit 60 includes an upper mold member 61 and a heater 70. The upper mold member 61 is an elongated member made of a material such as metal having an excellent electrical conductivity, and has one face (lower face) on which an upper mold frame portion 611 is formed. The upper mold frame portion 611 is projected in the shape that is fitted to the groove in the lower mold frame portion 501 of the lower mold holding tool 50. The upper mold frame portion 611 functions as a mold frame that shapes an upper portion in the hot pressing on the nonwoven fabric for forming into the protective member 21.

A mold frame shape obtained by combining the shape of the upper face of the lower mold frame portion 501 of the lower mold holding tool 50 and the shape of the lower face of the upper mold frame portion 611 of the upper mold member 61 defines an outer shape of the protective member 21 before being curved into a spiral shape. In the example shown in FIG. 2, the mold frame shape is a quadrangular cylinder shape, but the mold frame shape may be another shape such as a circular cylindrical shape, an elliptical cylindrical shape, a semicircular cylindrical shape, a hexagonal cylindrical shape, or other polygonal cylindrical shapes.

The heaters 70 respectively arranged in the lower mold member 41 and the upper mold member 61 are heating apparatuses that heat the nonwoven fabric for forming into the protective member 21 via the lower mold receiving portion 411 and the upper mold frame portion 611 to a temperature lower than the melting point of the base fibers and higher than the melting point of the adhesive resin. As shown in FIG. 2, the heaters 70 may be respectively embedded in the lower mold member 41 and the upper mold member 61. Furthermore, the heaters 70 may be respectively attached to the outer faces of the lower mold member 41 and the upper mold member 61 in a thermally conductive manner.

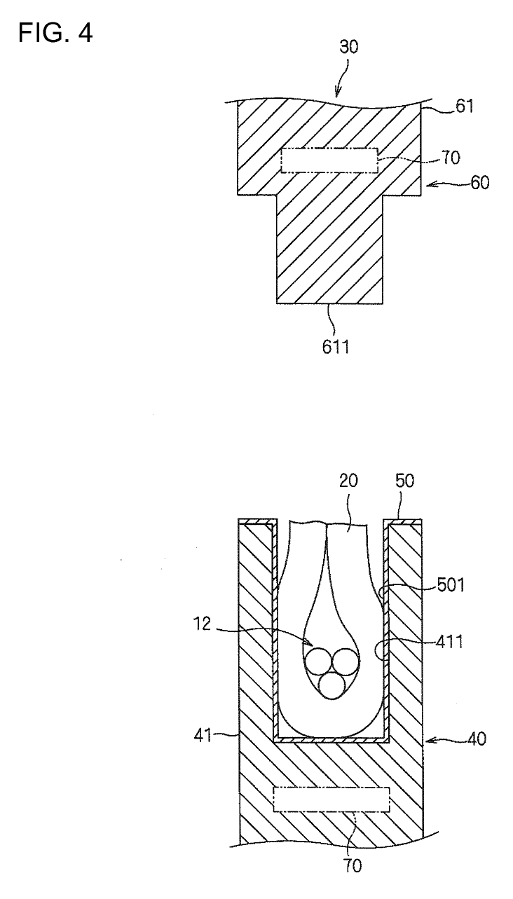

Next, a method for manufacturing the wire harness 1 will be described with reference to FIGS. 4 to 9. The wire harness 1 is manufactured by performing processes in order of a nonwoven fabric enclosing process (first step), a hot pressing process (second step), a curving process (third step), and a cooling process (fourth step).

<Nonwoven Fabric Enclosing Process (First Step)>

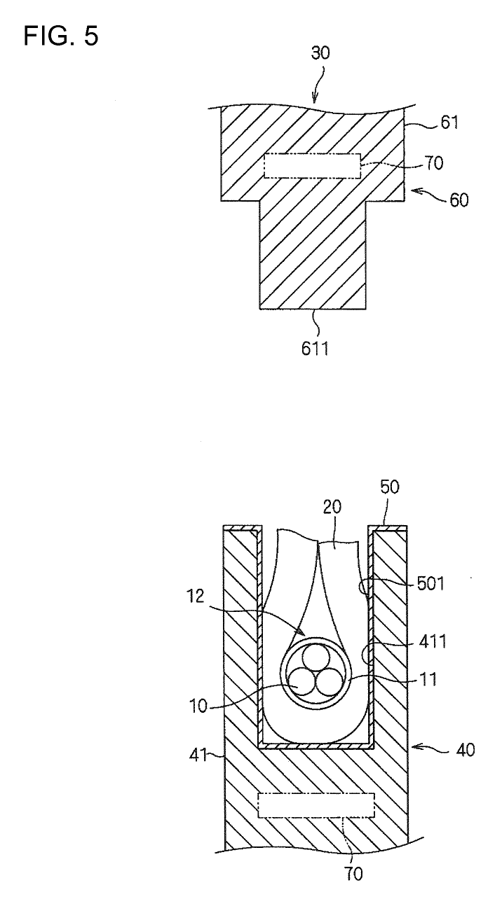

The nonwoven fabric enclosing process is a process that covers the portion around a protection-requiring range, corresponding to a portion in the longitudinal direction of the electrical wire bundle 12, with a nonwoven fabric 20. According to this process, as shown in FIGS. 4 and 5, the sheet-like nonwoven fabric 20 is disposed so as to be folded into two parts along the inner face of the groove-like lower mold frame portion 501, and the electrical wire bundle 12 is disposed so as to be held between the two parts of the folded nonwoven fabric 20. Furthermore, both sides of the two parts of the folded nonwoven fabric 20 are in contact with each other at a position near the opening of the upper portion of the lower mold frame portion 501.

Note that each of the electrical wires 10 in the electrical wire bundle 12 is subjected to insulating coating with an insulating material made of a resin such as polyvinyl chloride, but, as shown in FIG. 5, the electrical wire bundle 12 may be further bound by a binding tube 11. In this case, the nonwoven fabric 20 covers the electrical wire bundle 12 from the outer side of the binding tube 11.

The nonwoven fabric enclosing process is, for example, a process that inserts the electrical wire bundle 12 whose part in the longitudinal direction has been enclosed by the nonwoven fabric 20, into the groove-like lower mold frame portion 501 of the lower mold holding tool 50, and then attaches the lower mold holding tool 50 into which the nonwoven fabric 20 and the electrical wire bundle 12 have been inserted, to the lower mold member 41. The nonwoven fabric 20 is formed in the shape of a rectangle having a width that allows the nonwoven fabric 20 to enclose a predetermined range of the electrical wire bundle 12.

Note that the nonwoven fabric enclosing process also may be a process that inserts the electrical wire bundle 12 whose part in the longitudinal direction has been enclosed by the nonwoven fabric 20, to the groove-like lower mold frame portion 501 of the lower mold holding tool 50 that has been attached to the lower mold member 41.

<Hot Pressing Process (Second Step)>

The hot pressing process performed after the nonwoven fabric enclosing process is a process that heats the nonwoven fabric 20 covering the portion of the electrical wire bundle 12, in a mold configured by the lower mold frame portion 501 of the lower mold holding tool 50 and the upper mold frame portion 611 of the upper mold member 61, thereby molding the nonwoven fabric 20 into a cylindrical protective member covering a portion of the electrical wire bundle 12.

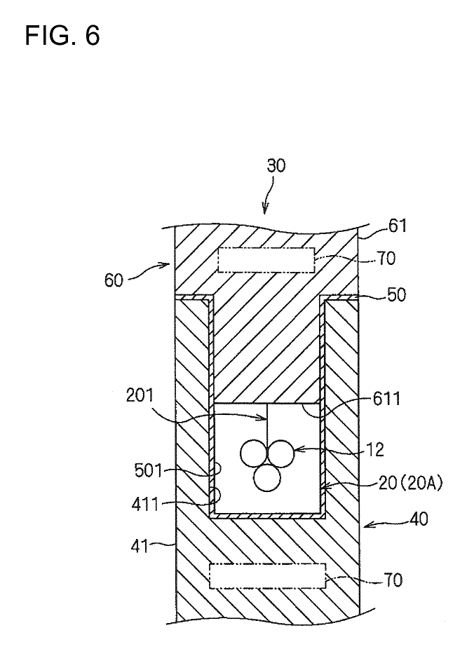

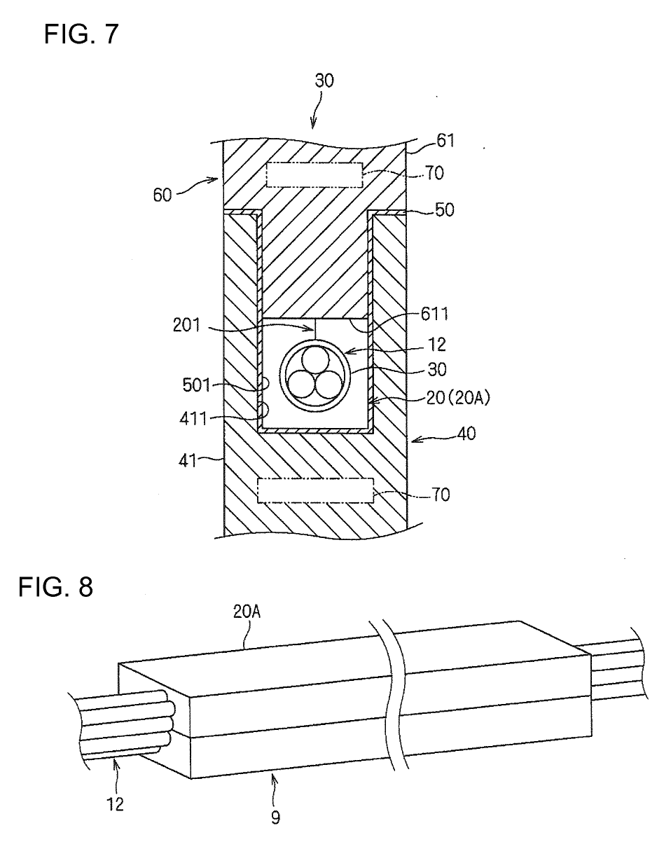

FIGS. 6 and 7 show a state in which, in the hot pressing process, the nonwoven fabric 20 covering a portion of the electrical wire bundle 12 is simultaneously compressed and heated in the mold configured by the lower mold frame portion 501 and the upper mold frame portion 611. Here, FIG. 7 shows a case in which the electrical wire bundle 12 is bound by the binding tube 11. In this case, the nonwoven fabric 20 is simultaneously compressed and heated in a state where it covers the electrical wire bundle 12 from the outer side of the binding tube 11.

More specifically, in a state where the nonwoven fabric 20 covering the portion of the electrical wire bundle 12 is inserted to the groove-like lower mold frame portion 501 of the lower mold holding tool 50 that has been attached to the lower mold member 41, the upper mold frame portion 611 of the upper mold member 61 is fitted to the lower mold frame portion 501. At that time, the heaters 70 respectively arranged in the lower mold unit 40 and the upper mold unit 60 are set to heat the lower mold frame portion 501 and the upper mold frame portion 611, that is, have been turned on. With the hot pressing process, the nonwoven fabric 20 covering the portion of the electrical wire bundle 12 is simultaneously compressed and heated in the mold from the outer side, and is therefore molded into a cylindrical protective member covering a portion of the electrical wire bundle 12. At that time, both side portions 201 of the nonwoven fabric 20 that have been brought into contact with each other are caused to adhere to each other by an adhesive resin melted due to heat, forming a cylindrical protective member.

In the hot pressing process, the nonwoven fabric 20 is heated by the heaters 70 to a temperature lower than the melting point of the base fibers contained in the nonwoven fabric 20 and higher than the melting point of the adhesive resin contained in the nonwoven fabric 20. The temperature and the time of the heating are set as appropriate according to the rigidity and the flexibility required for the protective member 21. Generally, in the hot pressing process, the nonwoven fabric 20 is molded into a member that has a higher rigidity and a higher shape retaining performance, as the heating temperature is higher, as the heating time is longer, and as the pressure applied is higher. On the other hand, in the hot pressing process, the nonwoven fabric 20 is molded into a member that is softer, more flexible, and more shock-absorbing, as the heating temperature is lower, as the heating time is shorter, and as the pressure applied is lower.

FIG. 8 is a perspective view of a wire harness including a protective member molded by the hot pressing process. The protective member obtained by molding the nonwoven fabric 20 in the hot pressing process is a substantially straight and cylindrical member. Furthermore, the protective member at a high temperature immediately after molding is relatively soft because the adhesive resin contained in the nonwoven fabric 20 has not been sufficiently cured. Hereinafter, the relatively soft cylindrical protective member at a high temperature obtained by molding the nonwoven fabric 20 in the hot pressing process is referred to as a hot protective member 20A. Furthermore, the wire harness provided with the hot protective member 20A is referred to as a hot wire harness 9. The protective member 21 is obtained by curving the hot protective member 20A into a spiral shape.

Since the nonwoven fabric 20 has a high thermal insulation performance, in the hot pressing process, the temperature of the inner face of the nonwoven fabric 20 in contact with the electrical wire bundle 12 is lower than that of the outer face in contact with the heated mold. Accordingly, the inner face of the hot protective member 20A in contact with the electrical wire bundle 12 is in close contact with the electrical wire bundle 12 in a state where the inner face is softer than the outer face.

<Curving Process (Third Step)>

The curving process performed after the hot pressing process is a process that curves part of the hot protective member 20A that has been molded in the hot pressing process, into a spiral shape, before it is cooled down to be cured. For example, the remaining portion excluding portions close to both ends in the hot protective member 20A is subjected to the curving process. This curving process is performed before the temperature of the hot protective member 20A at a high temperature after the hot pressing process decreases to a temperature equal to or lower than the melting point of the adhesive resin contained in the nonwoven fabric 20.

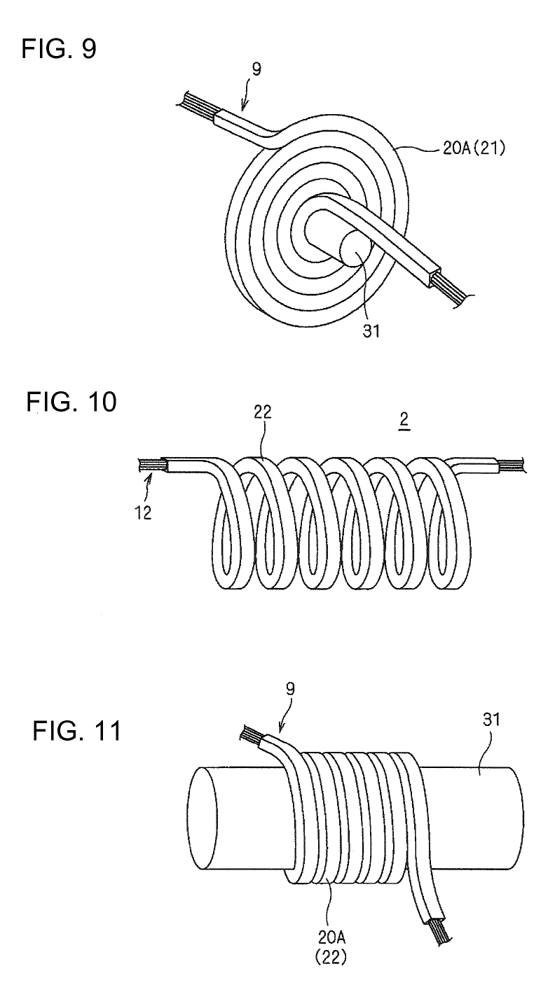

FIG. 9 is a perspective view showing the curving process for shaping the protective member 21 of the wire harness 1. As shown in FIG. 9, the curving process for producing the protective member 21 is a process that winds the hot protective member 20A around a rod-like support portion 31 in one turning direction in a sequentially overlapping manner. Accordingly, the hot protective member 20A forms a two-dimensional curve, and is curved into a spiral shape in which a curved portion is formed with a continuous turn in the same turning direction in the longitudinal direction. FIG. 9 shows the hot wire harness 9 in a state where the hot protective member 20A is wound around and supported by the support portion 31.

Note that the rod-like support portion 31 may have a surface with a circular cross-sectional shape. Furthermore, the cross-sectional shape of the surface of the rod-like support portion 31 may be an elliptical shape, or a polygonal shape such as a hexagonal shape or an octagonal shape.

<Cooling Process (Fourth Step)>

The cooling process performed after the curving process is a process that cools down the hot protective member 20A that has been wound around the rod-like support portion 31 in the curving process, while keeping the hot protective member 20A wound around the support portion 31. The cooling process may be either forced-air cooling or natural cooling in which the protective member 21 is left in a room at ordinary temperature for a predetermined period of time. Examples of the forced cooling include air cooling in which air at room temperature from a fan is blown to the protective member 21 and air cooling in which cold air emitted from a cooler such as a spot cooler is blown to the protective member 21. When the cooling process ends, the hot protective member 20A has been shaped into the spiral-shaped protective member 21. After the cooling process ends, the protective member 21 is detached from the support portion 31, forming the wire harness 1 shown in FIG. 1.

As described above, the wire harness 1 can be easily manufactured merely by following the procedure in which a portion in the longitudinal direction of the electrical wire bundle 12 is covered by the nonwoven fabric 20, the nonwoven fabric 20 is molded through the application of heat in a mold, and the molded protective member is curved into a spiral shape and is then cooled down before the protective member is cured. Furthermore, the wire harness 1 has a simple structure in which constituent elements such as a case for accommodating the electrical wire bundle 12 are not necessary, and thus can be manufactured at a low cost.

Next, a wire harness 2 according to the second embodiment of the present invention will be described with reference to FIG. 10. The configuration of the wire harness 2 according to the second embodiment is different from that of the wire harness 1 shown in FIG. 1 only in the shape of a protective member. In FIG. 10, the same constituent element as that shown in FIG. 1 is denoted by the same reference numeral. Hereinafter, only aspects of the wire harness 2 different from those of the wire harness 1 will be described.

As shown in FIG. 10, as in the case of the wire harness 1, the wire harness 2 includes a protective member 22 obtained by hot-pressing the nonwoven fabric 20, and the protective member 22 covers and protects a portion in the longitudinal direction of the electrical wire bundle 12. However, in the protective member 22 of the wire harness 2, the remaining portion excluding portions close to both ends forms a three-dimensional curve, and has a helical shape in which a curved portion is formed with a continuous turn in the same turning direction in the longitudinal direction. The shape of the protective member 22 can be also referred to as a coiled shape.

The wire harness 2 shown in FIG. 10 also has actions and effects similar to those of the wire harness 1. Furthermore, the wire harness 2 has an elongated shape on the whole. Accordingly, the wire harness 2 is particularly preferably applied when there are restrictions that a wire harness having a function of protecting the electrical wire bundle 12 and a function of absorbing an extra length of the electrical wire bundle 12 has to be disposed in an elongated space.

Next, a method for manufacturing the wire harness 2 will be described with reference to FIG. 11. As in the manufacturing process of the wire harness 1, the wire harness 2 is manufactured by performing processes in order of a nonwoven fabric enclosing process (first step), a hot pressing process (second step), a curving process (third step), and a cooling process (fourth step). In this example, the nonwoven fabric enclosing process and the hot pressing process in the manufacture of the wire harness 2 are the same as those when manufacturing the wire harness 1. Hereinafter, only the curving process and the cooling process in the manufacture of the wire harness 2 will be described.

<Curving Process (Third Step)>

The curving process performed after the hot pressing process is a process that curves part of the hot protective member 20A that has been molded in the hot pressing process, into a helical shape, before it is cooled down to be cured. For example, the whole of the hot protective member 20A or the remaining portion excluding portions close to both ends in the hot protective member 20A is subjected to the curving process. The curving process is performed before the temperature of the hot protective member 20A at a high temperature after the hot pressing process decreases to a temperature equal to or lower than the melting point of the adhesive resin contained in the nonwoven fabric 20.

FIG. 11 is a perspective view showing the curving process for shaping the protective member 22 of the wire harness 2. As shown in FIG. 11, the curving process for shaping the protective member 22 is a process that winds the hot protective member 20A around the rod-like support portion 31 in one turning direction not in an overlapping manner. Accordingly, the hot protective member 20A forms a three-dimensional curve, and is curved into a helical shape in which a curved portion is formed with a continuous turn in the same turning direction in the longitudinal direction. FIG. 11 shows the hot wire harness 9 in a state where the hot protective member 20A is wound around and supported by the support portion 31.

Note that the rod-like support portion 31 may have a surface with a circular cross-sectional shape. Furthermore, the cross-sectional shape of the surface of the rod-like support portion 31 may be an elliptical shape, or a polygonal shape such as a hexagonal shape or an octagonal shape.

<Cooling Process (Fourth Step)>

The cooling process performed after the curving process is a process that cools down the hot protective member 20A that has been wound around the rod-like support portion 31 in the curving process, while keeping the hot protective member 20A wound around the support portion 31. The cooling process may be either natural cooling or forced cooling. When the cooling process ends, the hot protective member 20A has been shaped into the helix-shaped protective member 22. After the cooling process ends, the protective member 22 is detached from the support portion 31, forming the wire harness 2 shown in FIG. 10.

As described above, the wire harness 2 also can be easily manufactured as in the case of the wire harness 1. Accordingly, as in the case of the wire harness 1, the wire harness 2 has a simple structure and thus can be manufactured at a low cost.

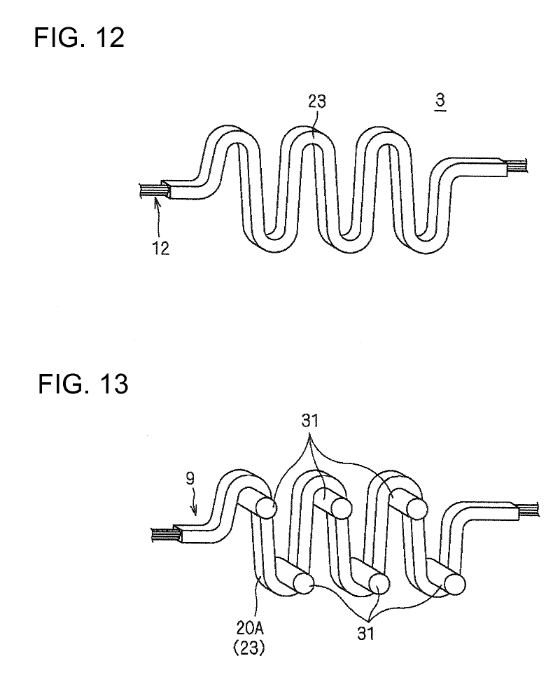

Next, a wire harness 3 according to the third embodiment of the present invention will be described with reference to FIG. 12. The configuration of the wire harness 3 according to the third embodiment is different from that of the wire harness 1 shown in FIG. 1 only in the shape of a protective member. In FIG. 12, the same constituent element as that shown in FIG. 1 is denoted by the same reference numeral. Hereinafter, only aspects of the wire harness 3 different from those of the wire harness 1 will be described.

As shown in FIG. 12, as in the case of the wire harness 1, the wire harness 3 includes a protective member 23 obtained by hot-pressing the nonwoven fabric 20, and the protective member 23 covers and protects a portion in the longitudinal direction of the electrical wire bundle 12. However, in the protective member 23 of the wire harness 3, the remaining portion excluding portions close to both ends forms a two-dimensional curve, and has a meander shape in which a plurality of curved portions are formed with intermittent turns in alternating turning directions in the longitudinal direction.

The wire harness 3 shown in FIG. 12 also has actions and effects similar to those of the wire harness 1. Furthermore, the wire harness 3 is on the whole thin and flat. Accordingly, the wire harness 3 is particularly preferably applied when there are restrictions that a wire harness having a function of protecting the electrical wire bundle 12 and a function of absorbing an extra length of the electrical wire bundle 12 has to be disposed in a narrow space.

Next, a method for manufacturing the wire harness 3 will be described with reference to FIG. 13. As in the manufacturing process of the wire harness 1, the wire harness 3 is manufactured by performing processes in order of a nonwoven fabric enclosing process (first step), a hot pressing process (second step), a curving process (third step), and a cooling process (fourth step). In this example, the nonwoven fabric enclosing process and the hot pressing process in the manufacture of the wire harness 3 are the same as those when manufacturing the wire harness 1. Hereinafter, only the curving process and the cooling process in the manufacture of the wire harness 3 will be described.

<Curving Process (Third Step)>

The curving process performed after the hot pressing process is a process that curves part of the hot protective member 20A that has been molded in the hot pressing process, into a helical shape, before it is cooled down to be cured. For example, the whole of the hot protective member 20A or the remaining portion excluding portions close to both ends in the hot protective member 20A is subjected to the curving process. The curving process is performed before the temperature of the hot protective member 20A at a high temperature after the hot pressing process decreases to a temperature equal to or lower than the melting point of the adhesive resin contained in the nonwoven fabric 20.

FIG. 13 is a perspective view showing a curving process for shaping the protective member 23 of the wire harness 3. As shown in FIG. 13, the curving process for shaping the protective member 23 is a process that catches the hot protective member 20A on each of a plurality of rod-like support portions 31 arranged in a line such that the hot protective member 20A turns in alternating turning directions. Accordingly, the hot protective member 20A forms a two-dimensional curve, and is curved into a meander shape in which a plurality of curved portions are formed with intermittent turns in alternating turning directions in the longitudinal direction. FIG. 13 shows the hot wire harness 9 in a state where the hot protective member 20A is caught on and supported by the plurality support portions 31.

Note that the rod-like support portions 31 may each have a surface with a circular cross-sectional shape. Furthermore, the cross-sectional shape of the surface of each rod-like support portion 31 may be an elliptical shape, or a polygonal shape such as a hexagonal shape or an octagonal shape.

<Cooling Process (Fourth Step)>

The cooling process performed after the curving process is a process that cools down the hot protective member 20A that has been caught on each of the plurality of rod-like support portions 31 arranged in a line in the curving process, while keeping the hot protective member 20A caught on the support portions 31. The cooling process may be either natural cooling or forced cooling. When the cooling process ends, the hot protective member 20A has been shaped into the meander-shaped protective member 23. After the cooling process ends, the protective member 23 is detached from the support portions 31, forming the wire harness 3 shown in FIG. 12.

As described above, the wire harness 3 also can be easily manufactured as in the case of the wire harness 1. Accordingly, as in the case of the wire harness 1, the wire harness 3 has a simple structure and thus can be manufactured at a low cost.

The wire harnesses 1 to 3 described above are preferably applied as a wire harness that connects a fixed portion and a movable portion. For example, the wire harnesses 1 to 3 are preferably applied as a wire harness that is connected to an electrical device disposed in a movable portion, such as a steering wheel whose height is adjusted by a tilt mechanism or a slide door, in an automobile.

Furthermore, the wire harnesses 1 to 3 are preferably applied as a wire harness for a support member to which an electrical device is attached in an automobile, wherein the wire harness connects an electrical device attached from a front face side of the support member to an attachment hole of the support member and a device disposed on a back face side of the support member. In this case, the wire harnesses 1, 2, and 3 are extended when being pulled out from the back face side of the support member via the attachment hole to the front face side, and are contracted after the electrical device has been attached to the attachment hole of the support member. For example, the wire harnesses 1 to 3 are preferably applied as a wire harness that is connected to a measuring instrument attached to an instrument panel from the front face side.

In the foregoing embodiments, the number of times of winding the protective members 21 and 22 and the number of curved portions in the protective member 23 are freely set according to applications.

1. A wire harness (1, 2), comprising:
an electrical wire (10); and
a protective member (21, 22) that is a member obtained by heat-molding a nonwoven fabric (20), that covers a portion in a longitudinal direction of the electrical wire (10), and that has a curved portion formed with a continuous turn in the longitudinal direction.

2. The wire harness (1) according to claim 1, wherein at least part of the protective member (21) forms a two-dimensional curve, and has a spiral shape in which a curved portion is formed with a continuous turn in the same turning direction in the longitudinal direction.

3. The wire harness (2) according to claim 1, wherein at least part of the protective member (22) forms a three-dimensional curve, and has a helical shape in which a curved portion is formed with a continuous turn in the same turning direction in the longitudinal direction.

4. A wire harness (3), comprising:
an electrical wire (10); and
a protective member (23) that is a member obtained by heat-molding a nonwoven fabric (20), that covers a portion in a longitudinal direction of the electrical wire (10), and that has curved portions formed with intermittent turns in the longitudinal direction.

5. The wire harness (3) according to claim 4, wherein at least part of the protective member (20) forms a two-dimensional curve, and has a meander shape in which a plurality of curved portions are formed with intermittent turns in alternating turning directions in the longitudinal direction.

6. A method for manufacturing a wire harness (1, 2) that includes an electrical wire (10) and a protective member (21, 22) covering a portion in a longitudinal direction of the electrical wire (10), comprising:
a first step of covering the portion in the longitudinal direction of the electrical wire (10) with a nonwoven fabric (20);
a second step of heating the nonwoven fabric (20) covering the portion of the electrical wire (10) in a mold (30), thereby molding the nonwoven fabric (20) into the protective member (20A) in a shape of a cylinder covering the portion of the electrical wire (10);
a third step of curving at least part of the protective member (20A) that has been molded in the second step into a shape in which a curved portion is formed with a continuous turn in the longitudinal direction; and
a fourth step of cooling down the protective member (21, 22) that has been curved in the third step, while keeping the protective member (21, 22) curved.

7. The method for manufacturing a wire harness (1) according to claim 6, wherein the third step is a process that winds the protective member (20A) that has been molded in the second step, around a rod-like support portion (31), in one turning direction in a sequentially overlapping manner, thereby causing at least part of the protective member (20A) to form a two-dimensional curve, and to be curved into a spiral shape in which a curved portion is formed with a continuous turn in the same turning direction in the longitudinal direction.

8. The method for manufacturing a wire harness (2) according to claim 6, wherein the third step is a process that winds the protective member (20A) that has been molded in the second step, around a rod-like support portion (31), in one turning direction not in an overlapping manner, thereby causing at least part of the protective member (20A) to form a three-dimensional curve, and to be curved into a helical shape in which a curved portion is formed with a continuous turn in the same turning direction in the longitudinal direction.

9. A method for manufacturing a wire harness (3) that includes an electrical wire (10) and a protective member (23) covering a portion in a longitudinal direction of the electrical wire (10), comprising:
a first step of covering the portion in the longitudinal direction of the electrical wire (10) with a nonwoven fabric (20);
a second step of heating the nonwoven fabric (20) covering the portion of the electrical wire (10) in a mold (30), thereby molding the nonwoven fabric (20) into the protective member (20A) in a shape of a cylinder covering the portion of the electrical wire (10);
a third step of curving at least part of the protective member (20A) that has been molded in the second step into a shape in which curved portions are formed with intermittent turns in the longitudinal direction; and
a fourth step of cooling down the protective member (23) that has been curved in the third step, while keeping the protective member (23) curved.

10. The method for manufacturing a wire harness (3) according to claim 9, wherein the third step is a process that catches the protective member (20A) that has been molded in the second step on each of a plurality of rod-like support portions (31) arranged in a line such that the protective member (20A) turns in alternating turning directions, thereby causing at least part of the protective member (20A) to form a two-dimensional curve, and to be curved into a meander shape in which a plurality of curved portions are formed with intermittent turns in alternating turning directions in the longitudinal direction.
